(19) United States
(12) Patent Application Publication
(10) Pub. No.: US 2023/0057089 A1
(43) Pub. Date: Feb. 23, 2023

(54) UPGRADE METHOD, COMPUTER SYSTEM, AND REMOTE UPGRADE DEVICE IMPLEMENTING EFFICIENT REMOTE UPGRADE

(71) Applicant: Xunmu Information Technology (Shanghai) Co., Ltd., Shanghai (CN)

(72) Inventor: Jiang WANG, Shanghai (CN)

(73) Assignee: Xunmu Information Technology (Shanghai) Co., Ltd., Shanghai (CN)

(21) Appl. No.: 17/873,814

(22) Filed: Jul. 26, 2022

(30) Foreign Application Priority Data
Aug. 19, 2021 (CN) 202110954171.8

(51) Int. Cl. G06F 8/654; G06F 11/10; H04L 67/00

(52) U.S. Cl. CPC G06F 8/654; G06F 11/1004; H04L 67/34

(57) ABSTRACT

An upgrade method, a remote upgrade device and a computer system implementing the upgrade method. The remote upgrade device transmits an upgrade notification to the computer system, comprising a list of block numbers involved for upgrading a new file. The new file comprises a plurality of file. The storage device comprises a plurality of storage blocks. Check codes of data in the storage block are transmitted to the remote upgrade device, each corresponding to one of the block numbers transmitted to the computer system. The remote upgrade device compares the received check codes with check codes of the file blocks corresponding to same block numbers in the new file. The upgrade method can skip the steps to transmit, erase and write existed file blocks based on the comparison result, and thus significantly improves the efficiency of remote upgrade.

### CROSS REFERENCE TO RELATED APPLICATION

This application claims the priority benefit of Chinese Patent Application Serial Number 202110954171.8, filed on Aug. 19, 2021, the full disclosure of which is incorporated herein by reference.

### BACKGROUND

### Technical Field

The application relates to an upgrade method, in particular to a method for a computer system to perform an efficient remote upgrade through a remote upgrade device.

### Related Art

Non-volatile memory devices are presently widely used in computer systems, such as servers, switches and other embedded systems. The most commonly used memory type is the flash memory device, adaptable for storing computer startup codes (BIOS or boot), operating system, application software, and etc. The files stored in flash memory, in various kind of application scenarios, need to be upgraded because of version upgrade, bug fix, function addition, and/or other reasons. FIG. 1 shows a conventional embedded system 120. The embedded system 120 comprises a firmware upgradable from a remote connection through a remote upgrade device 110. The remote upgrade device 110 may be a superior computer system located at a service station, a central control terminal, or manual controlled consoles. The embedded system 120 refers to a system where flash memory 128 is installed, such as a device with low-end hardware specs and poor computation power. The firmware 132 in the flash memory 128 is a program code file usually subjected as the target to be upgraded. Therefore, the storage blocks with certain addresses corresponding to the firmware 132 in the flash memory 128 are also referred to as the predetermined area 130 to be upgraded. The embedded system 120 may generally comprise a processor 122 connected to the memory device 124, and the firmware 132 in the flash memory 128 can be loaded to implement various forms of functions. The interface 126 in the embedded system 120 is configured to be connected to the remote upgrade device 110. The embedded system 120 is controlled by the remote upgrade device 110 to upgrade the firmware 132. For the flash memory 128, upgrading the firmware 132 means a procedure of erasing and writing the predetermined area 130 to be upgraded. As a known characteristics of the flash memory 128, a storage block must be erased before new data can be written. Both the erase and write operations are performed in a per-block fashion. Therefore, an upgrade method according to the prior arts is shown in FIG. 2.

FIG. 2 is a flowchart of firmware upgrade in a conventional embedded system 120. In step 201, a remote upgrade device 110 transmits a new file 404 to the embedded system 120 through the interface 126. In step 203, the embedded system 120 erases a predetermined area 130 to be upgraded in the flash memory 128 under the control of the processor 122. In step 205, the embedded system 120 writes the new file 404 to the erased predetermined area 130 to be upgraded in the flash memory 128. The disadvantage of this implementation method is that the remote upgrade device 110 must transmit the whole new file 404 to the embedded system 120. Even if there are identical data blocks already existed in the new file 404 as in the original file 402, there is no mechanism to omit the transmission. Therefore, in some scenarios that use low-speed buses (only a few hundred K bits of data can be transmitted per second), the time consumed for transmitting the already existed data blocks appears to be unnecessary and inefficient. That is, in the process of erasing and writing, the predetermined area 130 in the embedded system 120 to be upgraded must be erased before the whole new file 404 can be written, which takes a lot of time and increases the workload of the processor. The overall time consumption in the process is long, inducing busy system workload in the embedded system 120 which prevents the processor from promptly responding to other tasks, resulting in increased energy consumption, decreased performance, and poor user experience.

Therefore, an efficient firmware upgrade method is desirable for the embedded system to save unneeded data transmissions, erasures and writings.

### SUMMARY

It should be understood, however, that this summary may not contain all aspects and embodiments of the present invention, that this summary is not meant to be limiting or restrictive in any manner, and that the invention as disclosed herein will be understood by one of ordinary skill in the art to encompass obvious improvements and modifications thereto.

To solve the aforementioned technical problems, the application proposes an upgrade method for upgrading an original file stored in the predetermined area of the storage device to a new file. The predetermined area comprises a plurality of storage blocks with a predetermined block size, each corresponding to one of a plurality of block numbers. The new file is also divided into a plurality of file blocks, and each file block corresponds to one of the block numbers. Firstly, an upgrade notification is transmitted from a remote upgrade device to the storage device. The upgrade notification may comprise a list of block numbers, in which each block number is corresponding to one of the file blocks. Thereafter, a response from the storage device is transmitted to the remote upgrade device, comprising check codes of data in the storage blocks corresponding to the transmitted block numbers. In the remote upgrade device, the responded check codes are individually compared with check codes of corresponding file blocks. If the comparison finds a check code consistent, a corresponding file block is not transmitted, and therefore the upgrade time is saved. On the contrary, if the comparison finds a check code not matching, the remote upgrade device transmits a corresponding file block for the computer system to upgrade a corresponding storage block having the same block number.

The check codes may be derived using redundant cyclic check code CRC32, security hash function (SHA), or the message digest algorithm (MD5).

In a further embodiment, before the remote upgrade device transmits the upgrade notification, the remote upgrade device may divide the new file into a plurality of file blocks by the predetermined block size.

In a further embodiment, the check code of the file block is required for further verification. The check codes can be transmitted simultaneously by the remote upgrade device when transmitting the file block, or can be calculated by the computer system when the computer system receives the file block.

In a further embodiment, while the remote upgrade device transmits the file block for writing a storage block corresponding to the same block number, an erasure operation may be simultaneously performed on the storage block corresponding to the block number.

The present application also proposes an embodiment of a remote upgrade device. The remote upgrade device is adaptable for remotely upgrading data stored in the computer system, which at least comprises the following components. A first storage device may comprise a program code and a new file to be applied in the upgrade. A memory device is configured to be connected to the storage device for loading the program code. An interface may be adapted to connect the remote upgrade device to a computer system. The processor may be connected to the memory device, executing the program code to implement the aforementioned embodiment of upgrade method.

In a further embodiment, the interface of the remote upgrade device may be one of a network port, a serial port, an Inter-Integrated Circuit bus (I2C), a System Management bus (SMBus), a Peripheral Component Interconnect Express (PCIe), or an external sequence advanced technology attachment eSATA.

The present application also proposes an embodiment of an upgrade method, describing a procedure for remotely upgrading data by a remote upgrade device from the point of view of a computer system, whereby the original file in a predetermined area of the storage device is upgraded to a new file. Wherein the predetermined area comprises a plurality of storage blocks each having a predetermined block size. Each of the plurality of storage blocks corresponds to one of a plurality of block numbers. The new file comprises a plurality of file blocks, and each of the file blocks corresponds to one of the plurality of block numbers. Firstly, the computer system receives an upgrade notification sent from the remote upgrade device. The upgrade notification comprises a list of block numbers, in which each block number is corresponding to one of a plurality of file blocks. Thereafter, the computer system responds with one or more check codes of data in one or more storage blocks each corresponding to one of the plurality of block numbers. The check codes received by the remote upgrade device are respectively compared with check codes of corresponding file blocks. If a check code of a storage block corresponding to the block number matches a check code of a file block corresponding to the same block number, the file block will not be transmitted to upgrade the storage device, so that the data in the storage block of the storage device is maintained. If the check code of the storage block corresponding to the block number does not match the check code of the file block corresponding to the same block number, the remote upgrade device will transmit the file block, triggering the computer system to receive the file block and write the file block to the corresponding storage block.

In a further embodiment, the check code of the data in the storage block corresponding to the block number may be calculated by the computer system after receiving the upgrade notification transmitted by the remote upgrade device. On the other hand, the check code of the data in the storage block corresponding to the block number can also be prestored in the storage device before receiving the upgrade notice, so that the computer system can directly read the check code from the storage device after receiving the upgrade notice.

In a further embodiment, the check code of the file block may be received with the file block at the same time when receiving the file block transmitted by the remote upgrade device. On the other hand, the check code of the file block can also be calculated by the computer system after receiving the file block of the remote upgrade device. The check code of the file block may be adapted to verify whether the file block is correctly received. If the verification is incorrect, the file is not written into the corresponding storage block.

In a further embodiment, when the file block transmitted by the remote upgrade device is received and the correctness has been verified, the computer system can erase the storage block corresponding to the block number. The step of erasing the storage block corresponding to the block number and the step of receiving the file block transmitted from the remote upgrade device can be started at the same time.

In a further embodiment, after completely receiving the file block and erasing the storage block corresponding to the block number, the computer system can write the file block to the storage block corresponding to the block number. After writing the file block to the storage block corresponding to the block number, the computer system can store the check code of the file block.

The application further proposes an embodiment of a computer system for performing the aforementioned upgrade method in cooperation with the remote upgrade device. The computer system comprises at least the following components. An interface is adapted for connecting the computer system to the remote upgrade device. A storage device is connected with the interface, comprising a program code and a predetermined area, wherein the predetermined area comprises an original file. A memory device is connected with the interface for loading the program code. The processor is connected with the memory device, the storage device and the interface. The processor executes the program code to implement the aforementioned embodiment of upgrade method.

In a further embodiment, the interface of the computer system may be one of a network port, a serial port, an I2C bus, an SMBus, a PCIe bus, and an eSATA bus.

### BRIEF DESCRIPTION OF THE DRAWINGS

The features of the exemplary embodiments believed to be novel and the elements and/or the steps characteristic of the exemplary embodiments are set forth with particularity in the appended claims. The Figures are for illustration purposes only and are not drawn to scale. The exemplary embodiments, both as to organization and method of operation, may best be understood by reference to the detailed description which follows taken in conjunction with the accompanying drawings in which:

FIG. 1 shows a conventional embedded system 120;

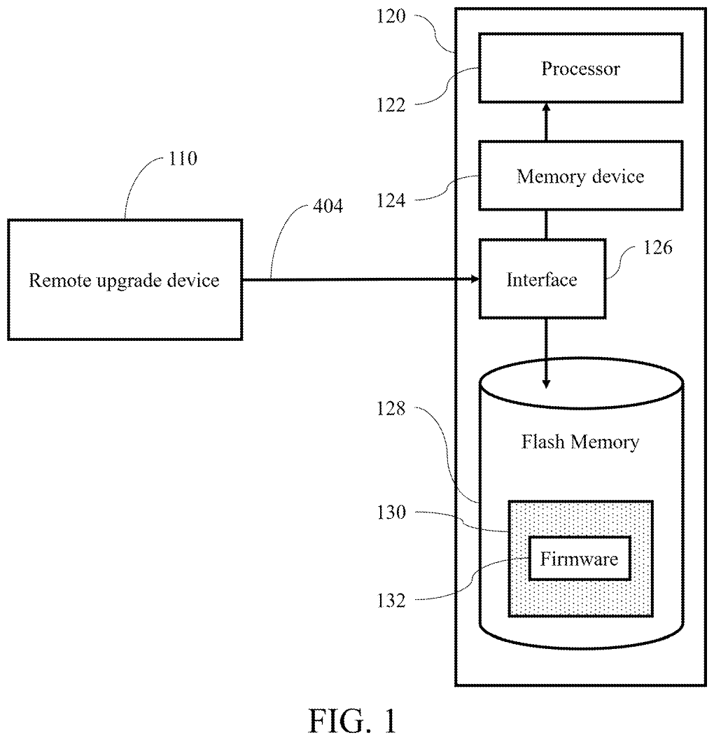

FIG. 2 is a flowchart of firmware upgrade in a conventional embedded system 120;

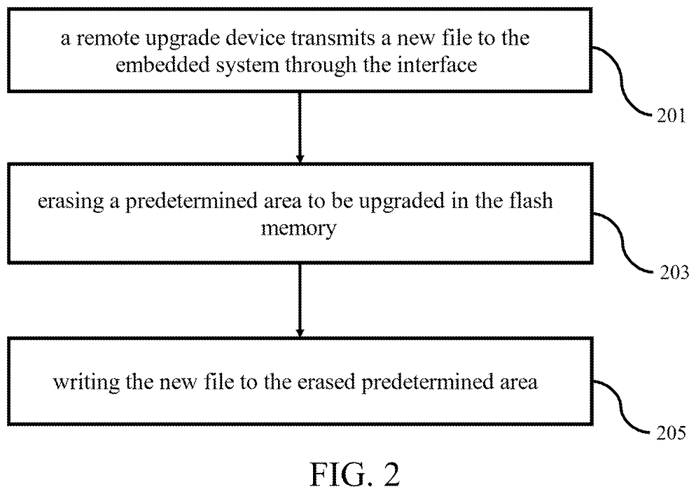

FIG. 3 shows a remote upgrade device and a computer system according to an embodiment of the present application;

FIG. 4 shows a block structure of the original file and the new file; and

FIG. 5 is a flowchart of an upgrade method according to an embodiment of the present application.

### DETAILED DESCRIPTION OF THE EMBODIMENTS

The present invention will now be described more fully hereinafter with reference to the accompanying drawings, in which exemplary embodiments of the invention are shown. This present invention may, however, be embodied in many different forms and should not be construed as limited to the embodiments set forth herein. Rather, these embodiments are provided so that this present invention will be thorough and complete, and will fully convey the scope of the present invention to those skilled in the art.

Certain terms are used throughout the description and following claims to refer to particular components. As one skilled in the art will appreciate, manufacturers may refer to a component by different names. This document does not intend to distinguish between components that differ in name but function. In the following description and in the claims, the terms “comprise/comprising” and “comprise/comprising” are used in an open-ended fashion, and thus should be interpreted as “comprising but not limited to”. “Substantial/substantially” means, within an acceptable error range, the person skilled in the art may solve the technical problem in a certain error range to achieve the basic technical effect.

The following description is of the best-contemplated mode of carrying out the invention. This description is made for the purpose of illustration of the general principles of the invention and should not be taken in a limiting sense. The scope of the invention is best determined by reference to the appended claims.

Moreover, the terms “comprise”, “contain”, and any variation thereof are intended to cover a non-exclusive inclusion. Therefore, a process, method, object, or device that comprises a series of elements not only comprise these elements, but also comprises other elements not specified expressly, or may comprise inherent elements of the process, method, object, or device. If no more limitations are made, an element limited by “comprise a/an . . . ” does not exclude other same elements existing in the process, the method, the article, or the device which comprises the element.

In the following embodiment, the same reference numerals are used to refer to the same or similar elements throughout the invention. The technical scheme in the embodiment of the application will be clearly and completely described below in combination with the accompanying drawings in the embodiment of the application. Obviously, the described embodiments are part of the embodiments of the application, not all of the embodiments. Based on the embodiments in the application, all other embodiments obtained by those skilled in the art without creative work belong to the scope of protection of the application.

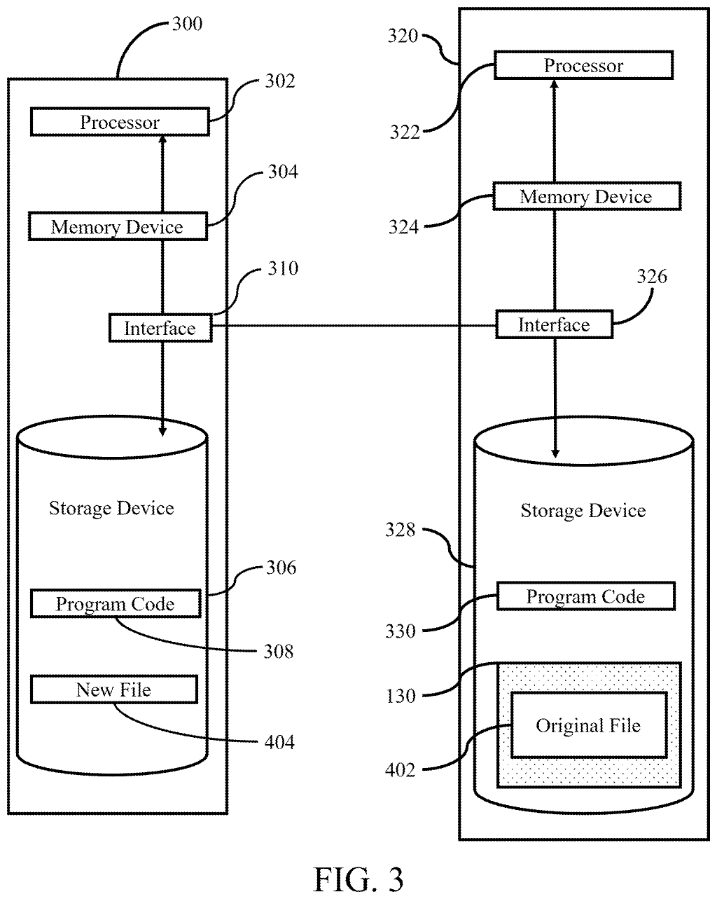

FIG. 3 shows a remote upgrade device 300 and a computer system 320 according to an embodiment of the present application. The remote upgrade device 300 and the computer system 320 are connected by an interface 310 and an interface 326. In some embodiments, the computer system 320 is an embedded system. In some embodiments, the computer system 320 may also be a general-purpose computer system, such as a server, personal computer, or notebook computer. The remote upgrade device 300 comprises a new file 404 stored in the storage device 306, wherein the new file 404 is adapted for upgrading the computer system 320. The storage device 306 also comprises a program code 308 loadable into the memory 304 and executable by the processor 302 to implement the upgrade method described in the present application, thereby the original file 402 stored in the storage device 328 in the computer system 320 is remotely upgraded to the new file 404. In some embodiments, the storage device 328 is, for example, but not limited to, a flash memory device. In the computer system 320, the original file 402 to be upgraded is stored in a predetermined area 130 of the storage device 328. The storage device 328 also comprises a program code 330, loadable into the memory device 324 and executable by the processor 322 to enable the computer system 320 to communicate with the remote upgrade device 300 through the interface 326 to cooperatively implement the upgrade method described in the present application. In an embodiment, the new file 404 will eventually be written into the area to be upgraded 130 to replace the original file 402. However, in the process of upgrading, it is not necessary to transfer all the data of the new file 404, but only the file blocks not existed in the original file 402. The interfaces 310 and 326 used by the computer system and the remote upgrade device of the embodiment of the application can be network ports, serial ports, I2C buses, SM-Buses, PCIe buses, or eSATA buses, and etc. When the interface is implemented with low-speed hardware specs, in particular, the advantages of the upgrade method of the embodiment of the present application can be significantly revealed.

The embodiments of the application provide improvements to the existing firmware upgrade process in a storage device such as but not limited to flash memory. Software or data upgrade (such as firmware) in flash memory devices has become one of the daily online services for general computer system commodities. Many product services will publish upgraded documents regularly or frequently. Every time an upgraded file is written to the flash memory, it is commonly seen that a large portion of the storage blocks remain the same, but only a few of the storage blocks are changed. For example, an upgraded file is provided just to fix a bug, or add a new function. Therefore, the iterative upgrade of file versions usually affects just a small proportion of the storage blocks. The subject application proposes a method to find out storage blocks involving data change before upgrading into the new file. Firmware upgrade can be accomplished by only upgrading changed storage blocks. On the remote upgrade device, instead of transmitting an entire data file, only file blocks that need to be upgraded are transmitted. This can greatly save the data transmission time. On the computer system 320, only the storage blocks with data change need to be erased and written with new file blocks. Since the proposed upgrade method does not need to process all storage blocks, the time consumption can be significantly reduced.

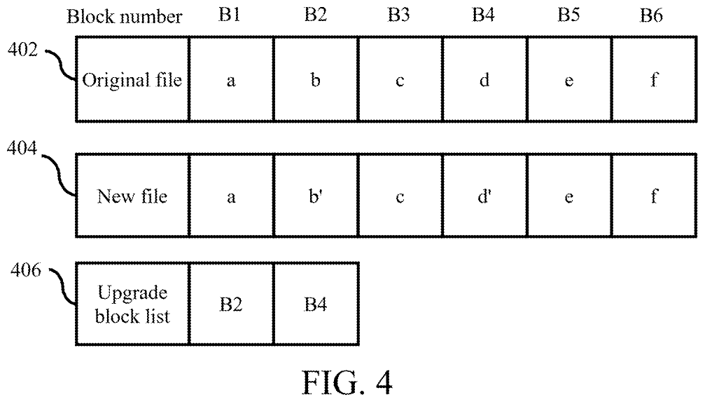

FIG. 4 shows a block structure of the original file and the new file 404 according to an embodiment of the present application. In the case that the storage device 328 is a flash memory, for example, the characteristic of the general flash memory is that the actions of erasing and writing are performed in a per-block fashion. The block size of a flash memory device may be 32 kilobytes (KB), 64 KB, or 128 KB, depending on the manufacturer, specification and model of flash memory. In contrast, the remote upgrade device can divide the new file 404 into multiple file blocks according to the same size as the storage block, and each file block is labeled with an independent block number. It can be clearly understood that each file block can form a corresponding relationship with the storage block number of the target storage address. The predetermined area 130 in the storage device 328 storing the original file 402 to be upgraded can be divided into a plurality of storage blocks in a specific block size. As illustrated in FIG. 4, the block numbers corresponding to multiple storage blocks can be represented as B1 to B6. The original file 402 stored in the storage device 328 is also divided into a plurality of file blocks each corresponding to a storage block where it is stored. Likewise, the original file 402 is divided into a plurality of file blocks and stored in the storage blocks with block numbers B1 to B6 respectively. The file blocks in each storage block have a unique check code. The check code is, for example, but not limited to, a hash value calculated by a HASH algorithm, and the hash operation is, for example, but not limited to CRC32, SHA, or MD5. Taking FIG. 4 as an example, a, b, c, d, e and f of the original file 402 represent file blocks with different check codes, wherein the check codes are corresponding to the block numbers B1 to B6. For example, a check code of a file block stored in the storage block with a block number B2 is represented as b. When a new file 404 is generated in the remote upgrade device 300, the new file 404 can also be divided into a plurality of file blocks according to the same specific block size as the original file 402, each corresponding to one of the block numbers. The check codes of these new file blocks can be calculated in advance when the new file 404 is generated. Taking FIG. 4 as an example, the check codes of each file block in the new file 404 can be expressed as a, b′, c, d′, e and f, each corresponding to one of the block numbers B1 to B6. The remote upgrade device 300 can transmit a list of the block numbers B1 to B6 to the computer system 320 so that the computer system 320 returns the check codes a to f of the original file corresponding to the list of block numbers B1 to B6, as shown in the original file 402 of FIG. 4. Thus, the remote upgrade device 300 can compare the check codes corresponding to the original file 402 and the new file 404, and generate an upgrade block list 406 according to the differences therebetween. Taking FIG. 4 as an example, a check code a of the file block of the original file 402 stored in the storage block of block number B1 and a check code a of a file block in the new file 404 corresponding to block number B1 are the same, indicating that the data of the two file blocks are the same and there is no change. Therefore, the file block of the original file 402 stored in the storage block of block number B1 does not need to be upgraded. The check code b of the file block of the original file 402 stored in the storage block of block number B2 and the check code b′ of the file block of the new file 404 corresponding to block number B2 are different, indicating that a data change has happened on the file block. Therefore, it is determined that the file block of the original file 402 stored in the storage block of block number B2 needs to be upgraded. For another example, an upgrade block list 406 is presented to indicate that the block numbers to be upgraded are B2 and B4. Thus, the remote upgrade device 300 can employ the upgrade block list 406 to transmit only the changed file blocks to efficiently accomplish the upgrade procedure of the computer system 320.

In some embodiments, the check code can be pre-calculated and stored in the storage device 328. When the remote upgrade device 300 transmits the upgrade notification with the list of the block numbers involved in the upgrade, the computer system 320 may directly read the check codes from the storage device 328 based on the list of block numbers to respond to the remote upgrade device 300. In some embodiments, the check codes may not be calculated in advance. When the remote upgrade device 300 transmits the upgrade notification with the list of block numbers involved in the upgrade, the computer system 320 instantly calculates the corresponding check codes for the block number involved and responds the check codes to the remote upgrade device 300.

In general, it can be understood that there is a corresponding relationship between the physical storage addresses and byte positions of a file stored in the storage device 328 of the computer system 320. However, the remote upgrade system does not necessarily in control of the correspondences between the index number of file blocks and the physical addresses of the storage device 328 of the computer system 320. When the remote upgrade device communicates with the computer system 320, the block number referred in the embodiments may represent physical addresses of storage blocks in the storage device 328. In another embodiment, it is also possible to use the index numbers of the file blocks in the original/new files as the block number. In further cases, the remote upgrade system may keep the original file when generating a new file 404. Therefore, the remote upgrade system is able to compare the new file 404 with the original file to determine the block numbers to be upgraded. Taking FIG. 4 as an example, the remote upgrade system determines that the block numbers to be upgraded are B2 and B4, and thus transmits only these block numbers to the computer system 320. Consequently, the computer system 320 responds check codes of storage blocks based on the block numbers, allowing the remote upgrade system to compare and determine the file blocks to be transmitted.

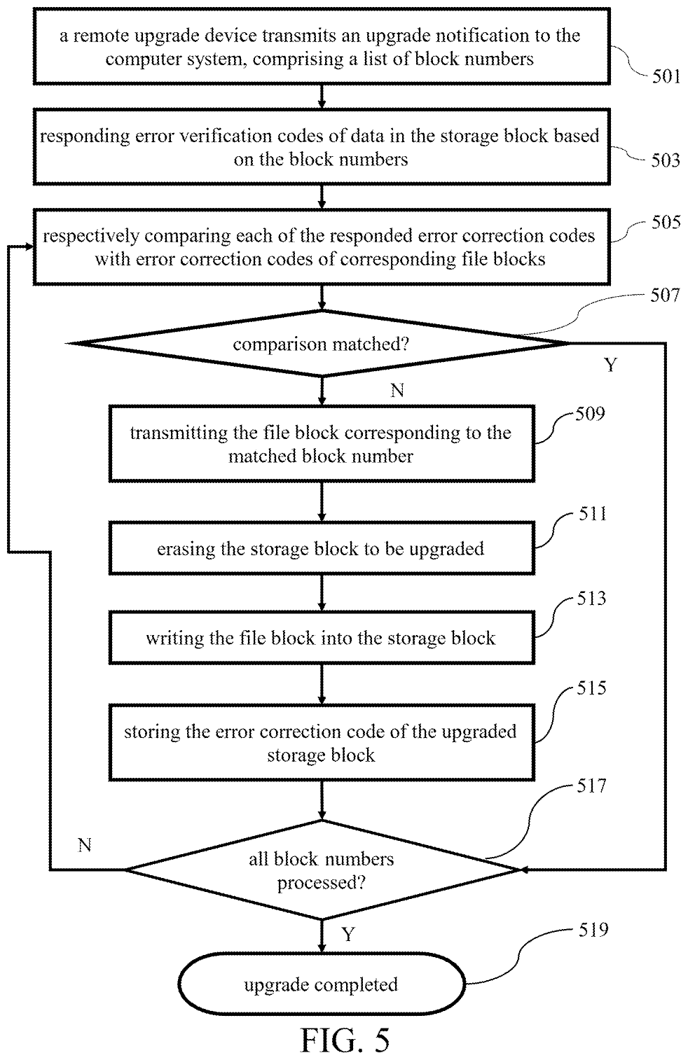

FIG. 5 shows a flowchart of an upgrade method according to an embodiment of the present application. The foregoing embodiments can be summarized as the following steps.

In step 501, a remote upgrade device transmits an upgrade notification to the computer system 320. For example, when the remote upgrade device provides a new file 404 to upgrade the computer system 320, the remote upgrade device can provide a list of block numbers involved in the new file 404 through the upgrade notification, for example, the block numbers of the file blocks.

In step 503, the computer system 320 responds the remote upgrade device with check codes of data in the storage block based on the block numbers. When the computer system 320 receives the block numbers involved in the new file 404, it can respond to the remote upgrade device with the check codes of the data in the storage block based on the list of block numbers transmitted with the upgrade notification. These check codes can be obtained by means of redundant cyclic check code (CRC32), secure hash algorithm (SHA), or message digest algorithm (MD5). The check codes of all block data may be precalculated and stored in the memory device of the computer system 320. Alternatively, the computer system 320 may instantly calculate the check codes based on the block numbers when receiving the block numbers.

In step 505, each of the check codes of the data in the storage blocks are respectively compared with a corresponding check code of one of the file blocks in the new file 404. When the remote upgrade device receives a response from the computer system 320, it starts a step of recursive comparison. In the embodiment, the remote upgrade device can divide the new file 404 into multiple file blocks according to the same size as the storage blocks in advance, and respectively allocate block numbers to each file block according to their destination storage block. Therefore, the remote upgrade device can employ the check codes responded by the computer system 320 to individually determine whether the file blocks corresponding to the block numbers respectively match the data in the storage blocks of the computer system 320.

In step 507, if a check code for a block number is matched, it means that a storage block corresponding to the block number does not need to be upgraded, and the process directly goes to step 517. In contrast, if the check codes are different, the remote upgrade device determines that the storage block corresponding to the block number needs to be upgraded.

In step 509, the remote upgrade device transmits a file block corresponding to the block number to the computer system 320. Compression mode can be selected for data transmission between the remote upgrade device and the computer system 320. Whether compressed transmission is adopted or not depends on the speed of processors at both ends and transmission channels. If the processor is fast and the transmission channel is slow, compression transmission is recommended. That is, the remote upgrade device compresses the data block to be transmitted first, and then transmits it. Thus, the computer system 320 can receive and decompress the data accordingly. On the other hand, if the transmission channel is fast, compression transmission is not recommended.

In step 511, when the computer system 320 confirms that the storage block corresponding to the block number needs to be upgraded, the storage block to be upgraded is erased.

In the present embodiment, the action of erasing the storage block in step 511 and the transmission data of the file block in step 509 can be started at the same time to further shorten the upgrade time.

In step 513, when the erase operation in step 511 is completed and the transmission of the file block is completed, the computer system 320 begins to write the file block into the storage block.

In step 515, the computer system 320 upgrades the corresponding check code according to the upgraded data stored in the storage block. The check code can be calculated by the processor in the process of upgrading, or it can be a value provided in advance. For example, when the check codes are processed in the remote upgrade device and the computer system 320, they can allocate a predetermined storage area in their respective memory device or storage device in advance to store check codes of data in respective storage blocks. In the remote upgrade device, a header data structure of the new file 404 or each new file block can be customized to store check codes of file blocks corresponding to each block number.

In step 517, it is determined whether all storage blocks involved by the block numbers have been processed. If not, step 505 is repeated. If all have been done, the upgrade procedure is ended in step 519.

Compared with the conventional flash data upgrade method, the embodiment of the present application highlights several obvious advantages. The amount of data transmitted between the two systems is reduced, which shortens the transmission time. In addition, since the processing of duplicate data is omitted, the number of storage blocks to be erased and written is reduced, and the operation time is shortened. Field experiments show that the overall upgrade time for a flash memory device can be shortened by more than 80%, which reduces the system load and energy consumption, makes the system respond faster and improves user satisfaction.

In a supplementary embodiment, the check codes of the file blocks in the new file 404 may be provided by the remote upgrade device when the computer system 320 receives the file block transmitted by the remote upgrade device. On the other hand, the check codes of the file blocks of the new file 404 can also be calculated by the computer system 320 after receiving the file blocks from the remote upgrade device. For example, in step 509, the check code of the file block may be adapted to verify whether the file block is correctly received. If the verification is incorrect, step 511 is not performed. Moreover, the computer system 320 can also require the remote upgrade device to retransmit the file block with incorrect verification. On the other hand, the computer system 320 may proceed to step 511 only when the correctness has been verified, wherein the storage block corresponding to the block number is erased and upgraded.

The upgrade method of the application can be applied to a wide range of applications. A computer system can be, but not limited to, a common intelligent device, a portable device, a wearable device in daily life, or a network device, a surveillance device, a smart appliance, an Internet of things device, and etc. In an embodiment, the remote upgrade device is a separated device remotely located away from the computer system, and the upgrade method is performed in a wired or wireless fashion. That is, when the upgrade method is performed, the upgrade notification may be transmitted from the remote upgrade device to the computer system in a wired or wireless connection, the remote upgrade device may receive the check codes from the computer system through the wired or wireless connection, and the remote upgrade device may transmit the file block to the computer system through the wired or wireless connection.

The embodiments of the application are described above in combination with the accompanying drawings, but the application is not limited to the above specific embodiments. The above specific embodiments are only schematic rather than restrictive. Those skilled in the art can make many forms under the Enlightenment of the application and without departing from the scope protected by the object and claims of the application, all belong to the protection of this application. It is to be understood that the term “comprises”, “comprising”, or any other variants thereof, is intended to encompass a non-exclusive inclusion, such that a process, method, article, or device of a series of elements not only comprise those elements but also comprises other elements that are not explicitly listed, or elements that are inherent to such a process, method, article, or device. An element defined by the phrase “comprising a . . . ” does not exclude the presence of the same element in the process, method, article, or device that comprises the element. Although the present invention has been explained in relation to its preferred embodiment, it does not intend to limit the present invention. It will be apparent to those skilled in the art having regard to this present invention that other modifications of the exemplary embodiments beyond those embodiments specifically described here may be made without departing from the spirit of the invention. Accordingly, such modifications are considered within the scope of the invention as limited solely by the appended claims.

What is claimed is:

1. An upgrade method for upgrading an original file stored in a predetermined area of a storage device into a new file, wherein the predetermined area comprises a plurality of storage blocks each having a predetermined block size and associated to one of a plurality of block numbers, the new file comprising a plurality of file blocks each associated to one of the plurality of block numbers; the upgrade method comprising:
transmitting an upgrade notification comprising a list of the block numbers of the plurality of file blocks;
receiving check codes of data stored in the storage blocks, wherein each of the received check codes corresponds to one of the block numbers in the list;
respectively comparing the received check codes with check codes of the plurality of file blocks;
when the comparison finds that a check code of a file block is matched to a received check code of a same block number, not transmitting the file block; and
when the comparison finds that the check code of the file block is inconsistent to the received check code of the same block number, transmitting the file block to upgrade a storage block corresponding to the same block number.

2. The upgrade method as claimed in claim 1, further comprising:
before transmitting the upgrade notification, dividing the new file into the plurality of file blocks each having the predetermined block size.

3. The upgrade method as claimed in claim 1, further comprising:
when transmitting the file block, transmitting the check code with the file block.

4. The upgrade method as claimed in claim 1, wherein the step of transmitting the file block further comprises erasing the storage block corresponding to the same block number.

5. The upgrade method as claimed in claim 1, wherein:
the storage device is installed in a computer system;
the step of transmitting the upgrade notification comprises transmitting the upgrade notification from a remote upgrade device to the computer system;
the step of receiving the check codes comprises the remote upgrade device receiving the check codes from the computer system; and
the step of transmitting the file block comprises the remote upgrade device transmitting the file block to the computer system to upgrade the storage block corresponding to the same block number.

6. A remote upgrade device for remotely upgrading data stored in a computer system comprising a storage device, comprising:
a first storage device, comprising a program code and a new file;
a memory device, connected to the first storage device for loading the program code; and
an interface, adaptable for remotely connecting the computer system;
a processor, connected with the memory device;
the processor executes the program code to implement an upgrade method for upgrading an original file stored in the storage device into the new file; wherein:
the storage device comprises a plurality of storage blocks each having a predetermined block size and associated to one of a plurality of block numbers, the new file comprising a plurality of file blocks each associated to one of the plurality of block numbers; and
the upgrade method comprises:
transmitting an upgrade notification comprising a list of block numbers of the plurality of file blocks;
receiving check codes of data stored in the storage blocks, wherein each of the received check codes corresponds to one of the block numbers in the list;
respectively comparing the received check codes with check codes of the plurality of file blocks;
when the comparison finds that a check code of a file block is matched to a received check code of a same block number, not transmitting the file block; and
when the comparison finds that the check code of the file block is inconsistent to the received check code of the same block number, transmitting the file block to upgrade a storage block corresponding to the same block number.

7. The remote upgrade device as claimed in claim 6, wherein:
the remote upgrade device transmits the upgrade notification through the interface to the computer system;
the remote upgrade device receives the check codes transmitted from the computer system through the interface; and
the remote upgrade device transmits the file block to the computer system through the interface to upgrade the storage block corresponding to the same block number.

8. An upgrade method for upgrading an original file stored in a predetermined area of a storage device into a new file, wherein the predetermined area comprises a plurality of storage blocks each having a predetermined block size and associated to one of a plurality of block numbers, the new file comprises a plurality of file blocks each associated to one of the plurality of block numbers; the upgrade method comprises:
receiving an upgrade notification comprising a list of the block numbers corresponding to the plurality of file blocks;
transmitting check codes of data stored in the storage blocks: wherein each of the transmitted check codes corresponds to one of the block numbers in the list, wherein the transmitted check codes are respectively compared with check codes of the plurality of file blocks, and when the comparison finds that a check code of a file block is matched to a transmitted check code of a same block number, the file block is not transmitted to the storage device; and
when the file block is received by the storage device, writing the file block into a corresponding storage block in the storage device.

9. The upgrade method as claimed in claim 8, further comprising:
after receiving the upgrade notification, calculating or reading check codes of data in the storage blocks according to the list of block numbers.

10. The upgrade method as claimed in claim 8, further comprising:
when receiving the file block, receiving the check code with the file block.

11. The upgrade method as claimed in claim 8, wherein writing the file block to the corresponding storage block comprises:
calculating the check code of the file block.

12. The upgrade method as claimed in claim 8, further comprising:
verifying whether the file block is correctly received according to the calculated check code of the file block; and
if the verification fails, the file block is not written into the corresponding storage block.

13. The upgrade method as claimed in claim 8, wherein writing the file block to the corresponding storage block comprises:
erasing the storage block corresponding to the block number, and thereafter writing the file block into the storage block corresponding to the block number.

14. The upgrade method as claimed in claim 13, further comprising:
substantially start erasing the storage block corresponding to the block number and receiving the file block at the same time.

15. The upgrade method as claimed in claim 8, further comprising:
after writing the file block to the storage block corresponding to the block number, storing the check code of the file block.

16. The upgrade method as claimed in claim 8, wherein:
the storage device is installed in a computer system;
the step of receiving the upgrade notification comprises the computer system receiving the upgrade notification transmitted from a remote upgrade device; and
the step of transmitting the check codes comprises the computer system transmitting the check codes to the remote upgrade device.

17. A computer system comprising:
an interface, configured to connect with a remote upgrade device;
a storage device, connected with the interface, comprising a program code and a predetermined area, wherein the predetermined area comprises an original file;
a memory device, connected with the storage device and the interface for loading the program code; and
a processor, connected to the memory device, the storage device and the interface, executing the program code to implement an upgrade method for upgrading the original file stored in the storage device into a new file, wherein:
the predetermined area comprises a plurality of storage blocks each having a predetermined block size and associated to one of a plurality of block numbers, the new file comprises a plurality of file blocks each associated to one of the plurality of block numbers; and
the upgrade method comprises:
receiving an upgrade notification comprising a list of block numbers corresponding to the plurality of file blocks;
transmitting check codes of data stored in the storage blocks: wherein each of the transmitted check codes corresponds to one of the block numbers in the list,
wherein the transmitted check codes are respectively compared with check codes of the plurality of file blocks, and when the comparison finds that a check code of a file block is matched to a transmitted check code of a same block number, the file block is not transmitted to the storage device; and
when the file block is received by the storage device, writing the file block into a corresponding storage block in the storage device.

18. The computer system as claimed in claim 17, wherein:
the step of receiving the upgrade notification comprises the computer system receiving the upgrade notification transmitted from the remote upgrade device; and
the step of transmitting the check codes comprises the computer system transmitting the check codes to the remote upgrade device.
